(19) United States
(12) Patent Application Publication
(10) Pub. No.: US 2025/0026365 A1
(43) Pub. Date: Jan. 23, 2025

(54) AUTONOMOUS PERCEPTION HUMAN-IN-LOOP VERIFICATION

(71) Applicant: Mercedes-Benz Group AG, Stuttgart (DE)

(72) Inventors: Aaron BROWN, Sunnyvale, CA (US); Thomas MONNINGER, Sunnyvale, CA (US); Vikram BHARADWAJ, Sunnyvale, CA (US)

(21) Appl. No.: 18/222,612

(22) Filed: Jul. 17, 2023

(51) Int. Cl. B60W 60/00; B60W 50/06; G06T 19/00

(52) U.S. Cl. CPC B60W 60/001; B60W 50/06; G06T 19/003; B60W 2554/4029; B60W 2554/80; B60W 2555/00

(57) ABSTRACT

A system can receive a perception output from an autonomous vehicle as the autonomous vehicle traverses a segment of a route. The perception output can be based on sensor data generated by a sensor suite of the autonomous vehicle. The system can generate, for an output device of a user, a human-perceptible three-dimensional rendering of an external environment of the vehicle based on the perception output. The human-perceptible three-dimensional rendering of the external environment can be as the user performs driving operations for the vehicle to traverse the segment of the route.

### BACKGROUND

Autonomous vehicle perception systems involve the acquisition and processing of real-time sensor data in order to safety traverse a road network environment.

### SUMMARY

A computing system is disclosed herein that receives a perception output from an autonomous-enabled vehicle as the vehicle traverses a route segment. In various examples, the perception output can be based on sensor data generated by a sensor suite of the vehicle. The computing system can further generate a human-perceptible, three-dimensional rendering of an external environment of the vehicle based on the perception output, and provide the three-dimensional rendering to an output device of a user (e.g., a headset display).

In certain examples, the computing system updates the three-dimensional rendering of the external environment in real-time as the user performs driving operations for the vehicle to traverse the route segment. In further examples, the computing system can generate feature representations for multiple objects of multiple types that are identified based on the perception output, where the feature representation reflects one or more physical characteristics of the object. In some aspects, these objects can comprise objects that are in motion (e.g., nearby pedestrians, vehicles, bicyclists, etc.), and the computing system generates the corresponding feature representation of the object in motion to be dynamic to reflect the object's motion.

In various implementations, the computing system can further generate the three-dimensional rendering of the external environment by generating various feature representations of traffic signage or traffic signals that are identified based on the perception output. In further implementations, these feature representations of such objects of interest can be accentuated or otherwise emphasized in the rendering to facilitate the user in perceiving these objects. The three-dimensional representation of the external environment can be rendered for a virtual reality (VR) headset worn by the user, or a display screen within a field of view of the user. In one aspect, the computing system can generate the three-dimensional representation as a simulation for the user, while the user performs the driving operations in a simulated environment, and the three-dimensional rendering can be updated by the computing system based on the perception output and/or the driving operations performed by the user. In accordance with examples described herein, when a set of users can safely operate a vehicle using the perception output of the autonomous vehicle (e.g., in a real-world or simulated environment), the perception module of the autonomous vehicle may be certified (e.g., by a vehicle manufacturer and/or safety authority).

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system for providing human-in-loop verification of an autonomous perception output, in accordance with examples described herein;

FIG. 2 is a block diagram illustrating a computing system including specialized modules for providing human-in-loop verification of an autonomous perception output, according to examples described herein;

FIG. 3 is a diagram illustrating a vehicle computing system including a rendering module for providing a perception output to a human driver, according to examples described herein; and

FIGS. 4 and 5 are flow charts describing example methods of providing perception outputs from autonomous vehicles to output devices for validating perception systems, in accordance with the various examples described herein.

### DETAILED DESCRIPTION

Advance driver assistance systems (ADAS) and autonomous driving systems may include perception and motion planning modules that function to process sensor data from vehicle sensors (e.g., LIDAR sensors, cameras, ultrasonic sensors, radar sensors, etc.) to generate a sensor-fused environment with detected objects of interest labeled or otherwise specified (e.g., via comparison with an autonomy map). Based on this perception output, motion prediction of surrounding external entities (e.g., pedestrians, bicyclists, other vehicles, etc.) and motion planning of the vehicle can be performed such that the autonomous vehicle can safely traverse along a travel path. It is contemplated that the verification and certification of autonomous driving systems may be necessary for autonomous vehicle operation on public road networks. In accordance with embodiments described herein, the task of certifying the autonomous driving system may be parsed into separate autonomous driving tasks, with the certification of the perception tasks being separated from the motion planning tasks in the manner described herein.

As provided herein, the perception tasks can be performed by a perception module of a vehicle computing system, and can include processing raw or pre-processed sensor data to identify objects of interest (e.g., traffic signage, traffic signals, other vehicles, pedestrians, bicyclists, lane markings, crosswalks, additional road details, curbs, and the like). In certain implementations, the perception tasks can further include classifying the objects of interest to generate a perception output. For example, each type of object of interest in the perception output can be labeled, provided with dedicated bounding box, and/or visually modified to enable a motion prediction module and motion planning module of the autonomous vehicle to perform their respective tasks. It is contemplated that the ability of drivers to operate a vehicle using the perception output can be indicative of the robustness and safety of the perception functions of the autonomous vehicle, which can be utilized for the certification of the perception aspect of the autonomous drive system.

As provided herein, an “autonomy map” or “autonomous driving map” can comprise a ground truth map recorded by a mapping vehicle using various sensors (e.g., LIDAR sensors and/or a suite of cameras or other imaging devices) and labeled (manually or automatically) to indicate traffic objects, right-of-way rules, and other driving rules for any given location. In variations, an autonomy map can involve reconstructed scenes using decoders from encoded sensor data recorded and compressed by vehicles. For example, a given autonomy map can be human-labeled based on observed traffic signage, traffic signals, and lane markings in the ground truth map. In further examples, reference points or other points of interest may be further labeled on the autonomy map for additional assistance to the autonomous vehicle. Autonomous vehicles or self-driving vehicles may then utilize the labeled autonomy maps to perform localization, pose, change detection, and various other operations required for autonomous driving on public roads. For example, an autonomous vehicle can reference an autonomy map for determining the traffic rules (e.g., the speed limit) at the vehicle's current location, and can dynamically compare live sensor data from an on-board sensor suite with a corresponding autonomy map to safely navigate along a current route.

In certain implementations, the computing system can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

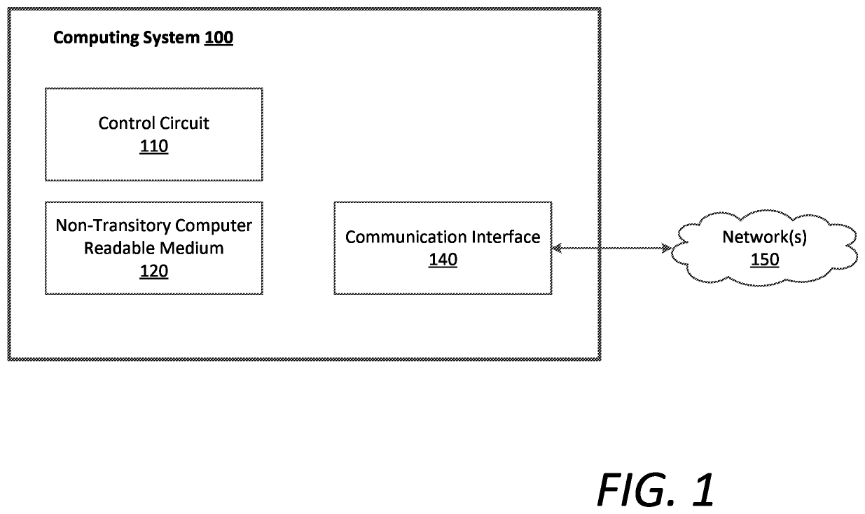

FIG. 1 is a block diagram depicting an example computing system for generating a fused environment representation for a vehicle, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”). In variations, the control circuit 110 and/or computing system 100 can be included on one or more servers (e.g., backend servers).

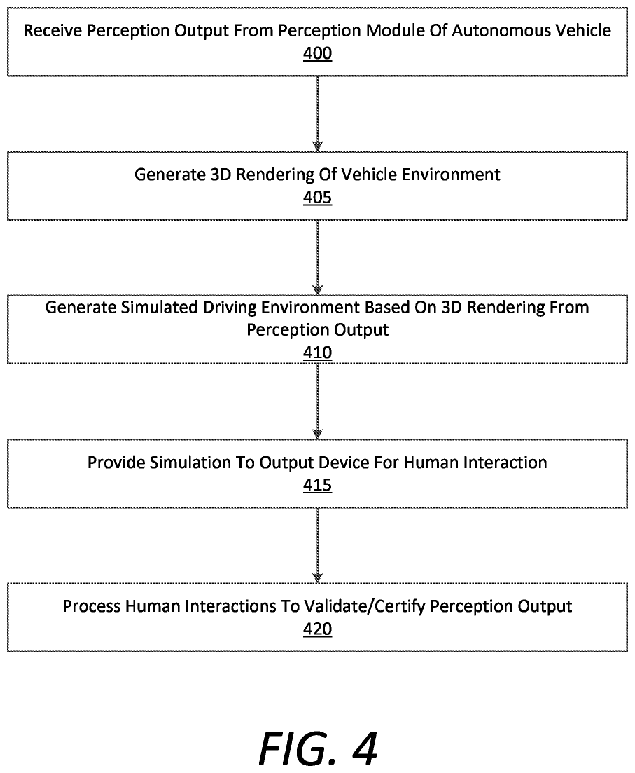

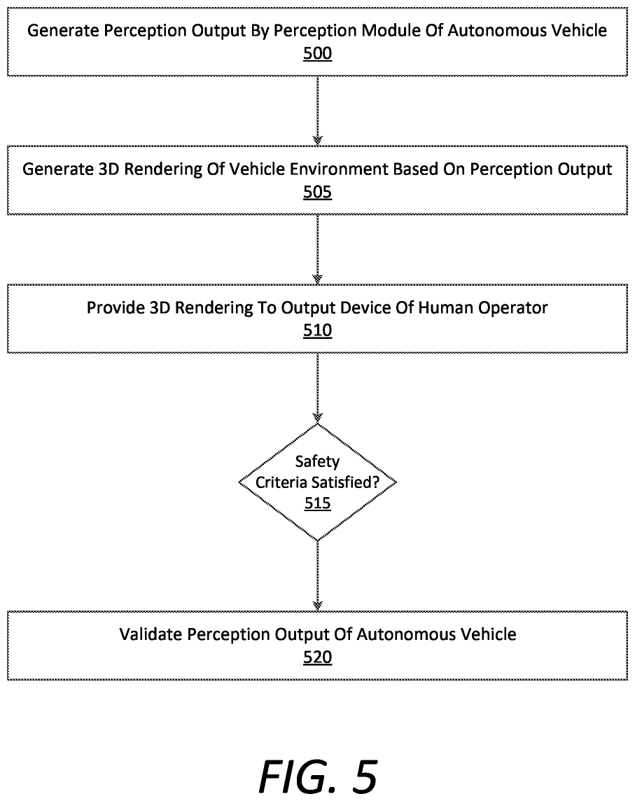

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 4 and 5.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

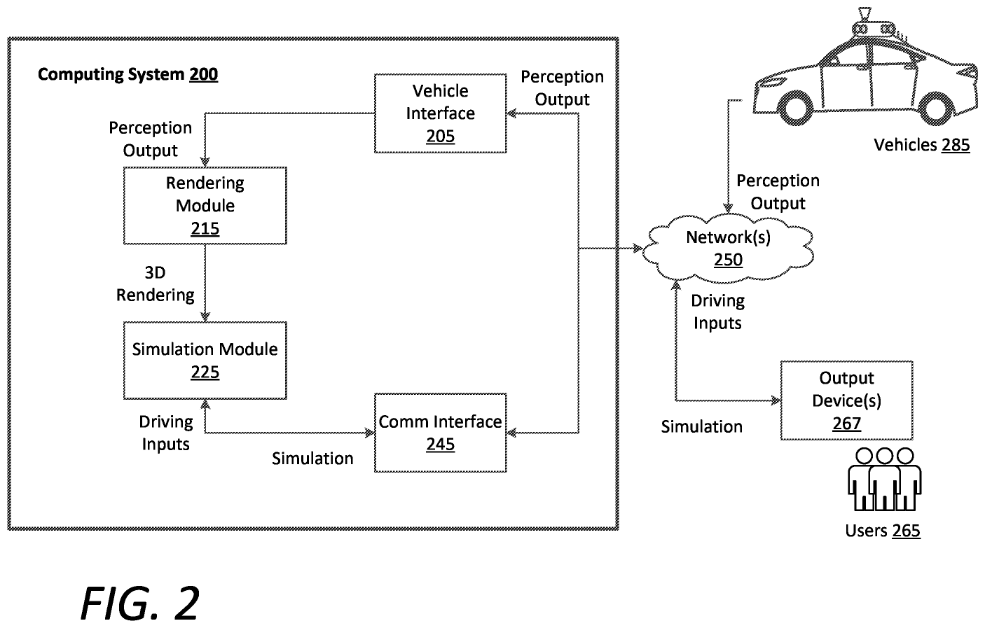

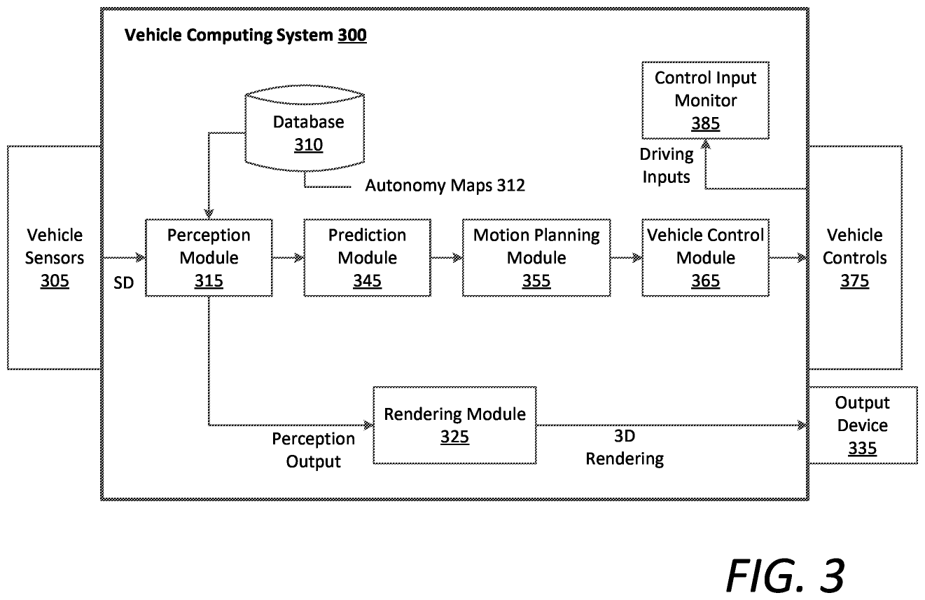

As an example embodiment, the computing system 100 can comprise a backend computing system, such as computing system 200 described with respect to FIG. 2, a vehicle computing system described with respect to FIG. 3, or a combination of both. As discussed in detail below, the computing system 100 can comprise a rendering module and simulation module that provide a user with a three-dimensional rendering of a surrounding environment of an autonomous vehicle based on the perception output of the autonomous vehicle, and facilitates a driving simulation that enables the user to operate a simulated vehicle in the three-dimensional rendering.

As further discussed in detail below, the computing system 100 can comprise a vehicle computing system that includes a perception module and rendering module. In such implementations, the driver physically sits at the controls of the vehicle and is provided with a three-dimensional rendering based on the perception output of the perception module (e.g., via a head-worn computing device, such as a virtual reality headset). The driver may then control the vehicle control mechanisms (e.g., accelerator pedal, brake pedal, steering mechanism, directional signals, etc.) based on the three-dimensional rendering, which can provide for an evaluation of the perception output. As described with examples herein, these implementations can support the evaluation and certification of perception systems that are provided as components of autonomous drive systems of autonomous vehicles.

### System Description

FIG. 2 is a block diagram illustrating a computing system 200 including specialized modules for providing human-in-loop verification of an autonomous perception output, according to examples described herein. In certain examples, the computing system 200 can include a vehicle interface 205 to enable the computing system 200 to communicate over one or more networks 250 with one or more autonomous-enabled vehicles 285. As provided herein, the autonomous vehicles 285 can include an on-board computing system that includes various modules for performing perception, motion prediction, motion planning, and vehicle control operations.

In certain examples, the perception operations can include processing sensor data generated by the sensors of the autonomous vehicles 285, which can include any combination of LIDAR sensors, radar sensors, image sensors or cameras, ultrasonic sensors, and the like. As such, the perception operations may include object detection and classification tasks, such as identifying and classifying external entities (e.g., other vehicles, pedestrians, bicyclists, other vulnerable road users, etc.), road signage and traffic signals, road and lane markings, and other useful features for navigating along a respective segment of a travel route. In further implementations, the perception output can include certain identifying characteristics of each identified object of interest, such as a label of the object of interest, color-coded object classifications (e.g., bounding polygons), and the like. In still further examples, the perception output can provide an indication of movement for each dynamic external entity, such as a direction of travel and/or estimated speed.

In various implementations, the computing system 200 can include a rendering module 215 that receives the perception output from the autonomous vehicle 285 and generates a human perceptible three-dimensional rendering based on the perception output. For example, the perception output can be generated by a perception module of the autonomous vehicle for the purpose of computer processing, in which the sensor data may be combined and fused in a manner that is readily processed by the autonomous drive system of the vehicle. In accordance with examples described herein, the rendering module 215 can process the perception output to generate the three-dimensional rendering specifically for human perception. For example, for each of multiple objects of multiple types that are identified by the perception output, the three-dimensional rendering can include a corresponding representation that reflects one or more physical characteristics of the type of object. As provided herein, the multiple objects can include one or more objects that are in motion, and the corresponding representation of each object of the objects can be generated to be dynamic to reflect a motion of the object. As further provided herein, these objects in motion can include pedestrians, other vulnerable road users, or other vehicles within proximity of the vehicle. Furthermore, the three-dimensional rendering can include feature representations of traffic signs and/or traffic signals that are identified by the perception output.

According to embodiments described herein, the three-dimensional rendering can be provided to a simulation module 225 of the computing system 200. The simulation module 225 can generate a virtual simulation of a driving environment that corresponds to the perception output of the autonomous vehicle 285. In certain examples, the computing system 200 can include a communication interface 245 that enables communications over the one or more networks 250 with output devices 267 operable by users 265. The users 265 can operate the output devices 267 which can include driving controls and one or more display devices (e.g., a virtual reality headset) that present the simulation generated by the simulation module 225 and enable the users 265 to control a simulated vehicle in the simulated environment. In such embodiments, the users 265 can operate vehicle controls of the output device 267 (e.g., accelerator pedal, brake pedal, steering mechanism, directional signals, etc.) to operate the simulated vehicle through the three-dimensional rendering as generated based on the perception output.

In various examples, the simulation can comprise a real-time driving simulation in which the user 265 provides driving inputs that are transmitted to and processed by the simulation module 225 to generate active responses by the simulated vehicle. As such, the user 265 can be provided with a simulated driving experience that is based on an actual perception output from a perception module of an autonomous vehicle. In certain examples, the driving inputs by the users 265 may be monitored by the simulation model 225 to evaluate the driving performance of the users 265. For example, the driving inputs may be monitored to determine whether the users 265 are struggling to operate the simulated vehicle using the three-dimensional rendering, such as determining whether the users 265 are providing sharp steering inputs, hard braking inputs, and the like. As described throughout the present disclosure, if the users 265 can operate a vehicle through the simulated driving environment that is generated based on the perception output of the autonomous vehicle, then the perception output can be evaluated for certification purposes separately from the motion prediction and planning aspects of the autonomous drive system.

### Vehicle Computing System

FIG. 3 is a diagram illustrating a vehicle computing system 300 including a rendering module for providing a perception output to a human driver, according to examples described herein. In various embodiments, the vehicle computing system 300 can be implemented on an autonomous-enabled vehicle that includes a suite of vehicle sensors 305 (e.g., a set of LIDAR, camera, and radar sensors) and a set of vehicle controls 375 that include an acceleration system (e.g., electric motors, engine, drive train, etc.), a braking system, a steering system, and the like. The vehicle computing system 300 can include a set of modules that operate to autonomously operate the vehicle throughout a road network. These modules can include a perception module 315, a prediction module 345, a motion planning module 355, and a vehicle control module 365. In certain implementations, the vehicle computing system 300 can include a database 310 storing a set of autonomy maps 312 that enable the perception module 315 to perform localization, pose, object detection and classification operations, and the like.

To autonomously operate the vehicle, the prediction module 345 receives the perception output from the perception module 315, which can identify any dynamic external entities, such as vulnerable road users (e.g., bicyclists and pedestrians) and other vehicles. The prediction module 345 can process the motion of the dynamic external entities to dynamically predict a future position of each entity. These future positions along with the perception output can be provided to a motion planning module 355 of the vehicle computing system 300, which can then dynamically generate a motion plan for the vehicle. Similar to a human driver, the motion plan can comprise the intent of the vehicle to be positioned at a future location based on all information in the surrounding environment of the vehicle.

In various aspects, the motion plan is executed by the vehicle control module 365, which can operate the vehicle controls 375 to autonomously drive the vehicle in accordance with the motion plan. This can include autonomous operation of the accelerator, braking system, steering mechanism, signaling system, and the like. As such, the perception module 315, prediction module 345, motion planning module 355, and vehicle control module 365 operate in concert to safely navigate the vehicle along a particular travel path (e.g., a route segment).

In accordance with examples described herein, the vehicle computing system 300 can include a rendering module 325 that receives the perception output from the perception module 315 and generates a human-perceptible three-dimensional rendering of the surrounding environment of the vehicle. The rendering module 325 included in the vehicle computing system 300 can operate substantially the same as the rendering module 215 as shown and described with respect to FIG. 2. As such, the three-dimensional rendering can be generated for the purpose of human perception, and can provide sensor data corresponding to the surrounding environment and identify the objects of interest (e.g., lane markings, signage, signals, external entities, etc.) for a human operator of the vehicle.

In various examples, the human operator can comprise a driver of the vehicle that can sit in a driver's seat and operate the vehicle controls 375. The vehicle computing system 300 can power down the prediction module 345, motion planning module 355, and the vehicle control module 365 to enable the driver to operate the vehicle controls 375 and thus drive the vehicle manually. The three-dimensional rendering can be outputted to an output device 335 (e.g., a display screen in the field of view of the driver, an augmented reality head-up display overlapping the windshield, or a virtual reality headset worn by the driver). Accordingly, the rendering module 325 can provide a real-time, three-dimensional rendering of the surrounding environment of the vehicle that enables the driver to physically operate the vehicle without viewing the actual external surroundings through the windows of the vehicle.

In certain embodiments, the driver can wear a virtual reality headset as the output device 335, which encompasses substantially the entire field of view of the driver, with the three-dimensional rendering being presented on the display devices within the headset. The driver can then operate the vehicle controls 375 to drive the vehicle along a travel path (e.g., at the driver's discretion or a preplanned travel path). In certain implementations, the vehicle computing system 300 can include a control input monitor 385 that can monitor and/or record the driver's inputs in operating the vehicle controls 375. These inputs can comprise steering, accelerator, braking inputs, signaling inputs, and the like. As provided herein, the driving inputs monitored and/or recorded by the control input monitor 385 can be evaluated to determine whether the driver can safely operate the vehicle using the three-dimensional rendering.

In the examples described with respect to FIGS. 2 and 3, the driving inputs of the driver in the simulated or real-world environments can be indicative of whether the perception output by the perception module 315 is providing adequate information for the downstream modules to autonomously operate the vehicle. As such, the perception output can be evaluated separately from other autonomous driving tasks for certification (e.g., by a safety authority and/or for an automotive safety integrity level (ASIL) rating).

### Methodology

FIGS. 4 and 5 are flow charts describing example methods of providing perception outputs from autonomous vehicles to output devices for validating perception systems, in accordance with the various examples described herein. In the below description of FIGS. 4 and 5, reference may be made to reference characters representing various features as shown and described with respect to FIGS. 1 through 3. Furthermore, the steps described with respect to the flow charts of FIGS. 4 and 5 may be performed by one or more of the computing systems 100, 200, 300 as shown and described with respect to FIGS. 1 through 3. Further still, certain steps described with respect to the flow charts of FIGS. 4 and 5 may be performed prior to, in conjunction with, or subsequent to any other step, and need not be performed in the respective sequences shown.

Referring to FIG. 4, at block 400, the computing system 200 may receive a perception output from the perception module 315 of a vehicle 285. As described herein, the perception output can comprise sensor-fused data from the sensor suite of the vehicle, which can comprise any combination of LIDAR sensors, image sensors, radar sensors, ultrasonic sensors, etc. At block 405, the computing system 200 can generate a three-dimensional rendering of the external vehicle environment based on the perception output from the perception module. In various examples, this rendering can be modified and tailored from the perception output for human viewing, and can include labeled or otherwise indicated objects of interest (e.g., external entities), lane markings, road signage, road signals, current driving rules, and the like.

In various examples, for each of multiple objects of multiple types that are identified by the perception output, the three-dimensional rendering can include a corresponding representation that reflects one or more physical characteristics of the type of object. As provided herein, the multiple objects can include one or more objects that are in motion, and the corresponding representation of each object of the one or more objects is generated to be dynamic to reflect a motion of the object. These objects in motion can include pedestrians that are on or near a roadway on which the vehicle is operating, or other vehicles adjacent to or within a certain distance of the vehicle. Furthermore, the three-dimensional rendering can include feature representations of traffic signs and/or traffic signals that are identified by the perception output.

In certain aspects, at block 410, the computing system 200 can generate a simulated driving environment based on the three-dimensional rendering from the perception output. The three-dimensional driving environment can enable a user 265 to operate a simulated vehicle within the environment (e.g., along an actual route traversed by the autonomous vehicle that provides the perception output). At block 415, the computing system 200 can provide the simulation to an output device 267 for human interaction by the user 265. The simulation can enable the user 267 to operate a simulated vehicle using vehicle controls in the simulated environment. In various examples, at block 420, the computing system 200 can process the human interactions and/or driving inputs by any number of users 267 to validate and certify the perception output, as described herein.

FIG. 5 is a flow chart describing a method of performing human-in-loop certification of a perception output of an autonomous vehicle in a real-world environment, according to examples described herein. Referring to FIG. 5, at block 500, a perception module 315 of a vehicle computing system 300 can generate a perception output based on sensor data from a sensor suite of the vehicle. At block 505, the computing system 300 can generate a three-dimensional rendering of the external environment of the vehicle based on the perception output. As provided herein, the three-dimensional rendering can be generated for human perception.

In various aspects, at block 510, the computing system 300 can provide the three-dimensional rendering to an output device 335, such as a virtual reality headset worn by the driver of the vehicle. It is contemplated that the perception module 315 in the computing system 300 can be implemented on a fleet of any number of vehicles, and therefore any number of human operators can test the perception output using the examples described herein. In doing so, the human operators can physically drive the vehicle along a route segment using only the information provided in the three-dimensional rendering. Additionally, the driving inputs provided by each of the drivers can cause the rendering to be updated dynamically and may be evaluated as the drivers perform the driving operations. In some aspects, the drivers may be interviewed and/or can provide input regarding whether operation of the vehicle is problematic, similar to real-world driving, or easier than real-world driving.

It is further contemplated that the driver need not be within the vehicle itself, but may rather remotely operate the vehicle using remote vehicle controls and the three-dimensional rendering based on the perception output. As provided herein, certification of the perception functions of an autonomous drive system may involve various safety criteria, which can be related to a human driving experience. Therefore, if a human driver is unable to operate the vehicle in a safe manner using the three-dimensional rendering, then certain elements of the safety criteria may be unmet. At decision block 515, the computing system 300 or an evaluation method, may monitor and evaluate the driving inputs of the drivers of the vehicles to determine whether the safety criteria for the perception output have been satisfied. If not, then more development may be required (e.g., perception model training and testing). However, if the safety criteria are satisfied, then, at block 520, the perception module of the autonomous vehicle may be validated accordingly.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A non-transitory computer-readable medium that stores instructions, which when executed by one or more processors a computing system, cause the computing system to perform operations that include:
receiving a perception output from an autonomous vehicle as the autonomous vehicle traverses a segment of a route, the perception output being based on sensor data generated by a sensor suite of the autonomous vehicle; and
generating, for an output device of a user, a human-perceptible three-dimensional rendering of an external environment of the autonomous vehicle based on the perception output;
wherein generating the human-perceptible three-dimensional rendering of the external environment includes updating the human-perceptible three-dimensional rendering as the user performs driving operations for the autonomous vehicle to traverse the segment of the route.

2. The non-transitory computer-readable medium of claim 1, wherein generating the human-perceptible three-dimensional rendering of the external environment includes generating, for each of multiple objects of multiple types that are identified by the perception output, a corresponding representation that reflects one or more physical characteristics of the type of object.

3. The non-transitory computer-readable medium of claim 2, wherein the multiple objects include one or more objects that are in motion, and wherein the corresponding representation of each object of the one or more objects is generated to be dynamic to reflect a motion of the object.

4. The non-transitory computer-readable medium of claim 3, wherein the multiple objects include a pedestrian that is on or near a roadway on which the autonomous vehicle operates.

5. The non-transitory computer-readable medium of claim 3, wherein the multiple objects include a second vehicle that is adjacent to or within proximity of the autonomous vehicle.

6. The non-transitory computer-readable medium of claim 1, wherein generating the human-perceptible three-dimensional rendering of the external environment includes generating a representation of a traffic sign or signal that is identified by the perception output.

7. The non-transitory computer-readable medium of claim 1, wherein the human-perceptible three-dimensional representation is generated in real-time while the user performs the driving operations from within the autonomous vehicle.

8. The non-transitory computer-readable medium of claim 7, wherein the human-perceptible three-dimensional representation is rendered for a virtual reality headset worn by the user.

9. The non-transitory computer-readable medium of claim 1, wherein the human-perceptible three-dimensional representation is generated as a simulation for the user while the user performs the driving operations in a simulated environment.

10. The non-transitory computer-readable medium of claim 1, wherein updating the human-perceptible three-dimensional rendering is based on at least one of the perception output or the driving operations.

11. A computing system comprising:
one or more processors;
a memory to store instructions;
wherein the one or more processors execute the instructions stored in the memory to perform operations that include:
receiving a perception output from an autonomous vehicle as the autonomous vehicle traverses a segment of a route, the perception output being based on sensor data generated by a sensor suite of the autonomous vehicle; and
generating, for an output device of a user, a human-perceptible three-dimensional rendering of an external environment of the autonomous vehicle based on the perception output;
wherein generating the human-perceptible three-dimensional rendering of the external environment includes updating the human-perceptible three-dimensional rendering as the user performs driving operations for the autonomous vehicle to traverse the segment of the route.

12. The computing system of claim 11, wherein generating the human-perceptible three-dimensional rendering of the external environment includes generating, for each of multiple objects of multiple types that are identified by the perception output, a corresponding representation that reflects one or more physical characteristics of the type of object.

13. The computing system of claim 12, wherein the multiple objects include one or more objects that are in motion, and wherein the corresponding representation of each object of the one or more objects is generated to be dynamic to reflect a motion of the object.

14. The computing system of claim 13, wherein the multiple objects include a pedestrian that is on or near a roadway on which the autonomous vehicle operates.

15. The computing system of claim 13, wherein the multiple objects include a second vehicle that is adjacent to or within proximity of the autonomous vehicle.

16. The computing system of claim 11, wherein generating the human-perceptible three-dimensional rendering of the external environment includes generating a representation of a traffic sign or signal that is identified by the perception output.

17. The computing system of claim 11, wherein the human-perceptible three-dimensional representation is generated in real-time while the user performs the driving operations from within the autonomous vehicle.

18. The computing system of claim 17, wherein the human-perceptible three-dimensional representation is rendered for a virtual reality headset worn by the user.

19. The computing system of claim 11, wherein the human-perceptible three-dimensional representation is generated as a simulation for the user while the user performs the driving operations in a simulated environment.

20. A computer-implemented method comprising:
receiving a perception output from an autonomous vehicle as the autonomous vehicle traverses a segment of a route, the perception output being based on sensor data generated by a sensor suite of the autonomous vehicle; and
generating, for an output device of a user, a human-perceptible three-dimensional rendering of an external environment of the vehicle based on the perception output;
wherein generating the human-perceptible three-dimensional rendering of the external environment includes updating the human-perceptible three-dimensional rendering as the user performs driving operations for the vehicle to traverse the segment of the route.
